(19) United States
(12) Patent Application Publication
(10) Pub. No.: US 2026/0225050 A1
(43) Pub. Date: Aug. 6, 2026

(54) MICROBUBBLE GENERATING DEVICE

(71) Applicants: SOOKMYUNG WOMEN'S UNIVERSITY INDUSTRY-ACADEMIC COOPERATION FOUNDATION, Seoul (KR); ACE inventer Inc., Seoul (KR)

(72) Inventors: Young Soo JOUNG, Seoul (KR); Byung-kuk KIM, Seoul (KR)

(21) Appl. No.: 19/151,423

(22) PCT Filed: Feb. 22, 2024
(86) PCT No.: PCT/KR2024/002296

§ 371 Date: Jul. 28, 2025

(30) Foreign Application Priority Data
Feb. 22, 2023 (KR) 10-2023-0023929
Apr. 18, 2023 (KR) 10-2023-0050456

(51) Int. Cl. B01F 23/2375; B01F 25/10

(52) U.S. Cl. CPC B01F 23/2375; B01F 25/10

(57) ABSTRACT

The present invention provides a microbubble generating device, including: at least one unit body, the unit body including: at least one ring-shaped supporter; a plurality of vortex-generating protrusions spaced apart at a predetermined interval along an outer circumferential surface of the supporter; an inner module provided inside the supporter; a plurality of coupling grooves spaced apart at a predetermined interval along an edge of one side of the supporter; and a plurality of coupling protrusions formed to protrude at positions corresponding to the coupling grooves and spaced apart at a predetermined interval along an edge of another side of the supporter such that the coupling protrusions can be fitted and coupled to the coupling grooves when the plural supporters are stacked, wherein, when the plural unit bodies are stacked, the vortex-generating protrusions are formed as a plurality of intermittent helical projections spaced apart at a predetermined interval along an outer circumferential surfaces of the plural supporters.

### TECHNICAL FIELD

The present invention relates to a device for generating microbubbles.

### BACKGROUND ART

Recently, technologies for generating a large quantity of microbubbles with a diameter of 1 μm or less inside a fluid have gained attention, as their effectiveness in cleaning, sterilization, and cooling has been verified.

To generate such microbubbles in large quantities, various conventional devices have been proposed, including those that reduce pressure and utilize shear force by increasing the flow velocity of a gas-dissolved liquid, those that use heat, mechanical energy, or ultrasound, and those employing agitators or mixers.

More recently, a technique has been proposed in which a large number of protrusions formed in a helical direction along the outer circumferential surface of a cylindrical body create vortices in a flowing fluid to generate a large quantity of microbubbles.

However, such structures are typically manufactured by mechanical processing, which makes mass production difficult and results in high manufacturing costs.

Accordingly, there is a demand for a technical solution to overcome these problems.

### DISCLOSURE

### Technical Problem

Therefore, the present invention has been made in view of the above problems, and it is one object of the present invention to provide a microbubble generating device manufacturable by injection molding.

It is another object of the present invention to provide a microbubble generating device capable of generating microbubbles on the inner side of a structure and allowing for easy assembly with adjustable diameter and length of the structure.

### Technical Solution

In accordance with an aspect of the present invention, the above and other objects can be accomplished by the provision of a microbubble generating device, including: at least one unit body, the unit body including: at least one ring-shaped supporter; a plurality of vortex-generating protrusions spaced apart at a predetermined interval along an outer circumferential surface of the supporter; an inner module provided inside the supporter; a plurality of coupling grooves spaced apart at a predetermined interval along an edge of one side of the supporter; and a plurality of coupling protrusions formed to protrude at positions corresponding to the coupling grooves and spaced apart at a predetermined interval along an edge of another side of the supporter such that the coupling protrusions can be fitted and coupled to the coupling grooves when the plural supporters are stacked, wherein, when the plural unit bodies are stacked, the vortex-generating protrusions are formed as a plurality of intermittent helical projections spaced apart at a predetermined interval along an outer circumferential surfaces of the plural supporters.

According to an embodiment, the inner module may have a conical shape with a predetermined height.

According to an embodiment, when the plural unit bodies are stacked, the inner module, which has the conical shape, may be fitted and coupled to a supporter of another one of the stacked unit bodies.

According to an embodiment, an angle formed between one of the coupling grooves and a coupling groove adjacent thereto may be 90 degrees based on a central axis of the supporter.

According to an embodiment, the inner module may include: an inner supporter; and a plurality of first inner vortex-generating protrusions spaced apart at a predetermined interval along an outer circumferential surface of the inner supporter.

According to an embodiment, the first inner vortex-generating protrusions may have a rhombus-shaped cross-section with a predetermined height and thickness.

According to an embodiment, the inner module may include: a plurality of inner coupling grooves spaced apart at a predetermined interval along an edge of one side of the inner supporter; and a plurality of inner coupling protrusions spaced apart from each other at a predetermined interval to protrude at corresponding positions along an edge of another side of the inner supporter, so as to be coupled to another one of the inner coupling grooves when the plural unit bodies are stacked.

According to an embodiment, the inner module may include: a central coupling protrusion protruding from a central axis; and a central coupling groove formed at a position corresponding to the central coupling protrusion so as to be engageable when the plural unit bodies are stacked.

According to an embodiment, the inner module may include a plurality of second inner vortex-generating protrusions spaced apart at a predetermined interval along an outer circumferential surface of the central axis.

According to an embodiment, the inner module may be another unit body having an outer diameter smaller than that of the supporter, and may be attachable to and detachable from the supporter.

According to an embodiment, the inner module may further include: a seating part provided on an inner side of the supporter so that another unit body is seated in the seating part; and a wing part configured to extend wing surfaces by engaging with vortex-generating protrusions of the another unit body when the another unit body is seated in the seating part.

According to an embodiment, the supporter of the another unit body may be seated in the seating part.

According to an embodiment, a direction in which the vortex-generating protrusions of the supporter extend outward from a center, and a direction in which the vortex-generating protrusions of the another unit body extend outward from a center, may coincide with each other.

According to an embodiment, the inner module of the another unit body may have a conical shape with a predetermined height.

### Advantageous Effects

In accordance with an embodiment of the present invention, a microbubble generating device can be manufactured by injection molding, making it easy to mass-produce at a low cost.

In addition, microbubbles can be generated on the inner side of a structure, and the diameter and length of the structure can be easily varied through simple assembly.

### DESCRIPTION OF DRAWINGS

FIG. 1 is a view illustrating the overall external appearance of a microbubble generating device according to an embodiment of the present invention.

FIG. 2 is a view illustrating one side of FIG. 1.

FIG. 3 is a view illustrating the overall external appearance of a unit body according to an embodiment of the present invention.

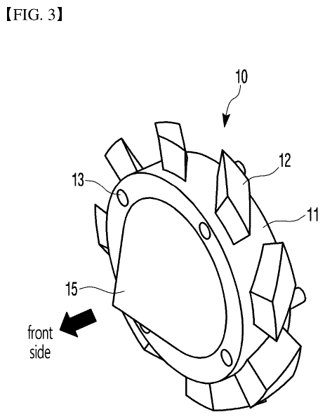

FIG. 4 is a view illustrating one side of FIG. 3.

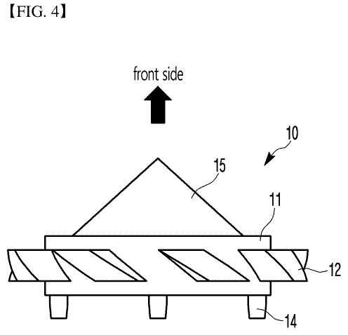

FIG. 5 is a front view of FIG. 3.

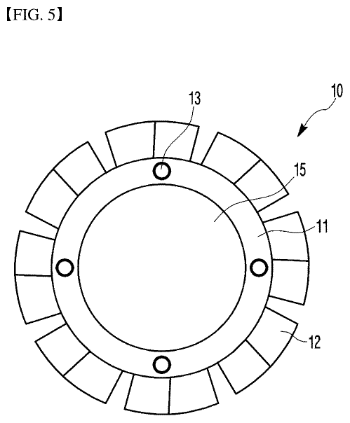

FIG. 6 is a rear view of FIG. 3.

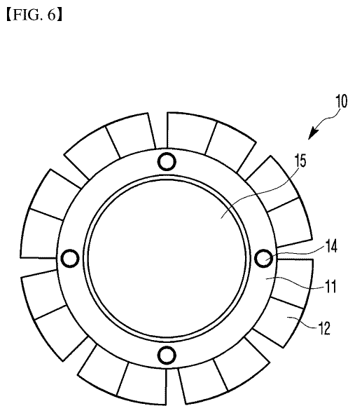

FIG. 7 is a view illustrating the overall external appearance of a unit body provided with an inner module according to another embodiment of the present invention.

FIG. 8 is a view illustrating the rear side of FIG. 7.

FIG. 9 is a view illustrating a side of FIG. 7.

FIG. 10 is a view illustrating the overall appearance in which a plurality of supporters as shown in FIG. 7 are stacked.

FIG. 11 is a view illustrating example shapes of vortex-generating protrusions according to an embodiment of the present invention.

FIG. 12 is a view illustrating the overall stacked configuration of a plurality of unit bodies having an inner module in which another unit body is combined, according to another embodiment of the present invention.

FIG. 13 is a side view of FIG. 12.

FIG. 14 is a view illustrating the overall view of the unit body shown in FIG. 12.

FIG. 15 is a front view of the unit body shown in FIG. 12.

FIG. 16 is a rear view of the unit body shown in FIG. 12.

FIG. 17 is an exploded perspective view of the unit body shown in FIG. 12.

FIG. 18 is a view illustrating a state where the innermost unit body is omitted from the unit body of FIG. 12.

FIG. 19 is a longitudinal sectional view of FIG. 18.

FIG. 20 is a view illustrating a state where the outermost unit body is omitted from the unit body of FIG. 12.

### BEST MODE

Hereinafter, the present invention will be described in detail by explaining exemplary embodiments of the invention with reference to the attached drawings. The same reference numerals in the drawings denote like elements, and a repeated explanation thereof will not be given. In addition, the suffixes “module” and “unit” of elements herein are used for convenience of description and thus can be used interchangeably and do not have any distinguishable meanings or functions. In the following description of the present invention, a detailed description of known functions and configurations incorporated herein will be omitted when it may make the subject matter of the present invention unclear. The features of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

The expression of singularity in the present specification includes the expression of plurality unless clearly specified otherwise in the context.

Also, the terms such as “include” or “comprise” may be construed to denote a certain characteristic, number, step, operation, component, or a combination thereof in the specification, but may not be construed to exclude the presence of or a possibility of addition of one or more other characteristics, numbers, steps, operations, components, or combinations thereof.

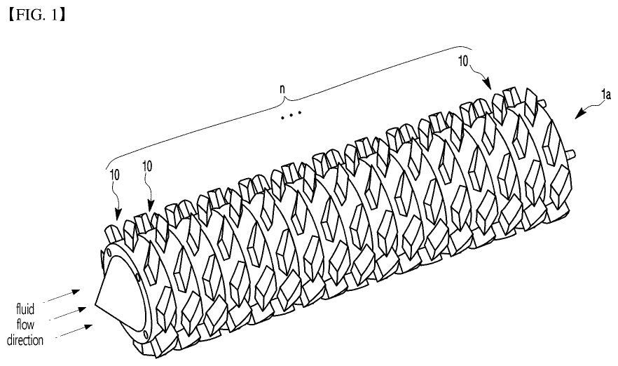

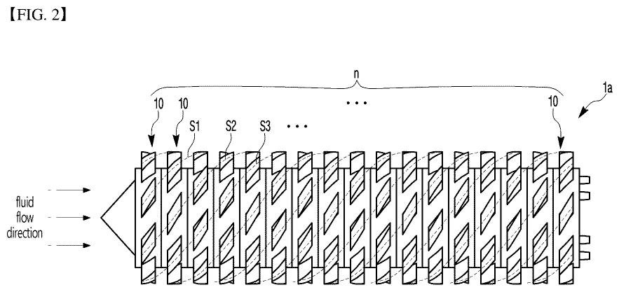

FIG. 1 is a view illustrating the overall external appearance of a microbubble generating device according to an embodiment of the present invention, and FIG. 2 is a view illustrating one side of FIG. 1.

As shown in FIGS. 1 and 2, a microbubble generating device 1a according to an embodiment of the present invention may have a structure in which a plurality of unit bodies 10, each having a ring-shaped supporter 11, are stacked in a fluid flow direction.

The supporter 11 has a hollow cylindrical shape with a short length or height, and when the plural unit bodies 10 having the supporters 11 of low height are stacked and coupled, the microbubble generating device 1a having an extended length may be formed in the fluid flow direction, so that the structure of the microbubble generating device 1a may be easily extended in length.

Each supporter 11 of the stacked unit bodies 10 includes a plurality of vortex-generating protrusions 12 spaced apart from each other at a predetermined interval along the outer circumferential surface. When the plural supporters 11 are stacked, the vortex-generating protrusions 12 of each supporter 11 may be positioned along a plurality of helical (or screw-shaped) paths S1 to S3 that surround the outer circumferential surface of the microbubble generating device 1a (see FIG. 2).

Here, the plural vortex-generating protrusions 12 arranged along the helical (or screw-shaped) paths may be provided intermittently, and the helical (or screw-shaped) paths S1 to S3 surrounding the outer circumferential surface of the microbubble generating device 1a may be formed at a predetermined interval therebetween.

Accordingly, the fluid flowing along the fluid flow direction may collide with the plural vortex-generating protrusions 12 at a predetermined pressure while flowing in a helical (or screw-shaped) manner along the outer circumferential surface of the microbubble generating device 1a. As a result, bubbles contained in the fluid may be broken into smaller bubbles, and by repeating this process, a large number of microbubbles may be formed.

According to an embodiment of the present invention, the unit bodies 10, each having the supporter 11 that includes the plural vortex-generating protrusions 12 spaced apart from each other by the predetermined interval along the outer circumferential surface, may be manufactured by injection molding, so that a long microbubble generating device 1a may be manufactured by stacking and coupling the plural unit bodies 10. Therefore, the time, cost, and processes required to machine the microbubble generating device 1a structure of this type may be reduced or omitted.

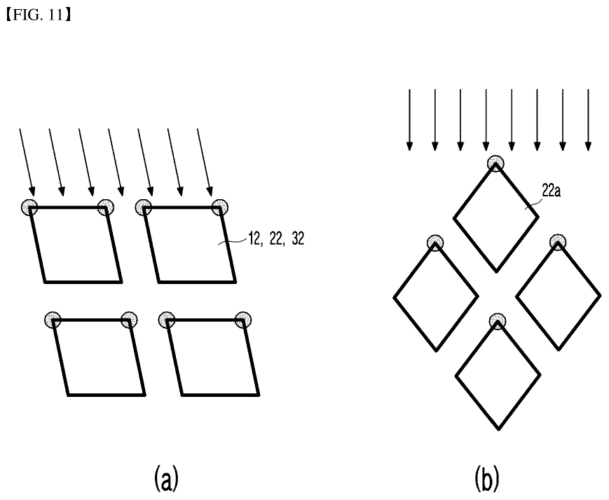

The present invention does not particularly limit the shape of the vortex-generating protrusions 12 that are spaced from each other at a predetermined interval on the outer circumferential surface of the supporter 11 and formed to protrude by a predetermined height from the outer circumferential surface. However, according to a preferred embodiment of the present invention, the vortex-generating protrusions 12 may have a cross-sectional shape of a parallelogram, as shown in FIG. 11(a), in which the top or bottom side faces the fluid flow direction, or may have a cross-sectional shape of a rhombus, as shown in FIG. 11(b), in which one vertex of the rhombus faces the fluid flow direction.

However, the present invention does not particularly limit the angle formed between each surface of the vortex-generating protrusions having a parallelogram or rhombus shape and the fluid flow direction, nor the shape of each surface (for example, flat or curved), and may follow any known configuration.

In addition, the number of vortex-generating protrusions 12 provided at a predetermined interval on the outer circumferential surface of the supporter 11 according to an embodiment of the present invention is not particularly limited.

However, when the supporter 11 having the plural vortex-generating protrusions 12 is stacked in a front and/or rear direction, each supporter 11 may be coupled in a twisted manner at a predetermined angle. To enable this, one side, specifically the front or rear side, of the supporter 11 according to an embodiment of the present invention may have a plurality of coupling grooves 13 formed along its edge at a predetermined interval. Correspondingly, the other side, specifically the rear or front side, of the supporter 11 may have a plurality of coupling protrusions 14 formed along its edge at a predetermined interval.

In this specification, the terms “front” and “rear” are defined based on the fluid flow direction, with the direction facing against the fluid flow direction referred to as the front.

Eventually, the coupling grooves 13 formed on one of the supporters 11 and the coupling protrusions 14 formed on another corresponding supporter 11 may be fitted and coupled to each other, and when one of the supporters 11 is coupled with another of the supporters 11, the one supporter 11 may be rotationally assembled at a predetermined angle, so that, as shown in FIG. 2, the plural vortex-generating protrusions 12 formed on the stacked plural supporters 11 may be intermittently arranged along the outer circumferential surface of the main body to form a plurality of helical (or screw-shaped) paths S1, S2, S3, . . . , Sn at a predetermined interval.

Here, the plural supporters 11 to be stacked may have the same shape, and the coupling grooves 13 and the coupling protrusions 14 may each be formed in sets of four at an equal interval along the edge of the ring-shaped supporter 11 such that multiple helical paths are formed by the vortex-generating protrusions 12 formed on the outer circumferential surface of each supporter 11 when the plural supporters 11 are stacked. The plural vortex-generating protrusions 12 provided on each supporter 11 may be formed in sets of eight at an equal interval. For example, an angle between one of the coupling grooves 13 provided with reference to the central axis of the supporter 11 and another adjacent coupling groove 13 may be 90 degrees, and likewise, an angle between one of the coupling protrusions 14 provided with reference to the central axis of the supporter 11 and another adjacent coupling protrusion 14 may also be 90 degrees.

Meanwhile, an inner module may be provided inside the supporter 11 according to an embodiment of the present invention.

According to a particular embodiment, the inner module may be conical in shape with a predetermined height, specifically formed to protrude from the inner circumferential surface of the supporter 11 toward the front side, i.e., facing the fluid flow direction.

The microbubble generating device 1a according to an embodiment of the present invention may generate microbubbles using the plural vortex-generating protrusions 12, and at the same time, reduce resistance to the flowing fluid through the conical inner module.

In addition, when the plural supporters 11 are stacked in the front-rear direction, the inner module of a supported supporter 11 to be stacked may be fitted and coupled into the supporter 11 positioned in the front direction. That is, when the corresponding coupling grooves 13 and coupling protrusions 14 are engaged during stacking and coupling of the plural supporters 11 according to an embodiment of the present invention, the conical inner module 15 located at the rear side may be inserted into the supporter 11 at the front side, thereby guiding the coupling direction between one supporter 11 and another supporter 11 in the front-rear direction and facilitating the coupling.

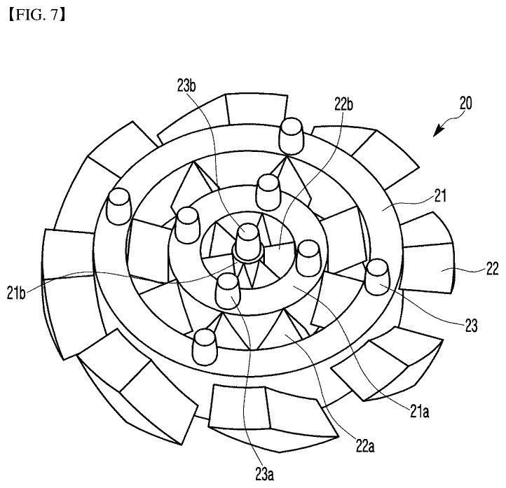

Meanwhile, an inner module according to another embodiment of the present invention may include a ring-shaped (or hollow cylindrical) inner supporter 21a; and a plurality of first inner vortex-generating protrusions 22a spaced apart from each other at a predetermined interval along the outer circumferential surface of the inner supporter 21a, as shown in FIGS. 7 to 10, unlike the conical shape of the previous embodiment.

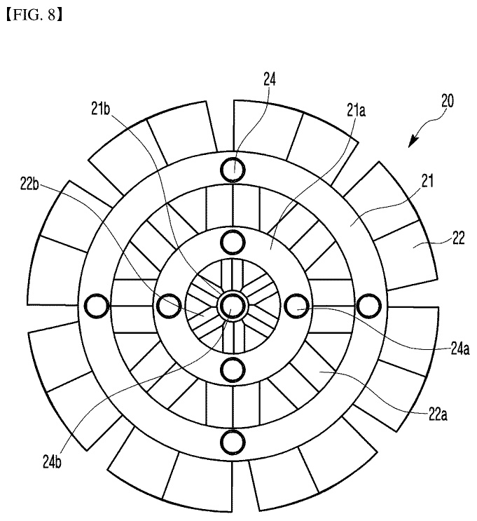

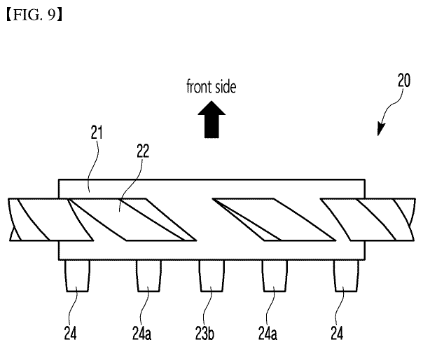

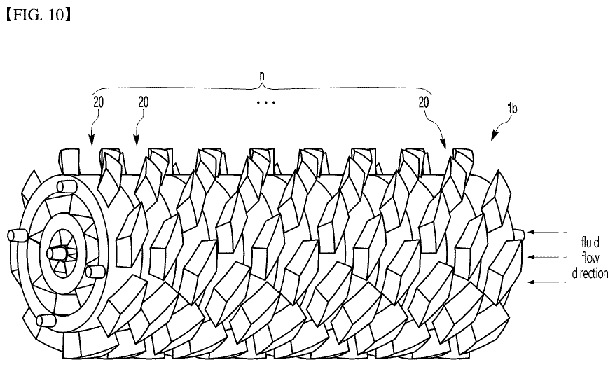

FIG. 7 is a view illustrating the overall external appearance of a unit body provided with an inner module according to another embodiment of the present invention; FIG. 8 is a view illustrating the rear side of FIG. 7; FIG. 9 is a view illustrating a side of FIG. 7; and FIG. 10 is a view illustrating the overall appearance in which a plurality of supporters as shown in FIG. 7 are stacked.

As shown in FIGS. 7 to 10, an inner module provided on the inner circumferential surface of a supporter 21 of a unit body 20 according to another embodiment of the present invention may include an inner supporter 21a having a plurality of first inner vortex-generating protrusions 22a formed at a predetermined interval along the outer circumferential surface, as described above.

Here, the inner circumferential surface of the supporter 21 and the inner supporter 21a may be fixedly coupled to each other via the first inner vortex-generating protrusions 22a. Although the shape of the first inner vortex-generating protrusions 22a is not particularly limited, it may have a cross-section of a parallelogram, in which the top or bottom side faces the fluid flow direction, as shown in FIG. 11(a), or a cross-section of a rhombus, in which one vertex faces the fluid flow direction, as shown in FIG. 11(b), so that when the fluid flowing along the fluid flow direction collides with the first inner vortex-generating protrusions 22a, the bubbles contained in the fluid may be broken into smaller bubbles.

Accordingly, as shown in FIGS. 7 to 10, the shape of the first inner vortex-generating protrusions 22a provided on the outer circumferential surface of the inner supporter 21a according to an embodiment of the present invention may differ from the shape of the vortex-generating protrusions 12 provided on the outer circumferential surface of the supporter 21. However, they are not limited thereto and may be the same, and the present invention is not particularly limited in this regard.

According to a particular embodiment, the first inner vortex-generating protrusions 22a of the inner supporter 21a may have a cross-sectional shape of a rhombus with one of its vertices facing the fluid flow direction, and the vortex-generating protrusions 12 provided on the outer circumferential surface of the supporter 11 may have a cross-sectional shape of a parallelogram with either the top or bottom side facing the fluid flow direction.

If the first inner vortex-generating protrusions 22a of the inner supporter 21a according to an embodiment of the present invention have a cross-sectional shape of a parallelogram arranged to face the fluid flow direction—similar to the vortex-generating protrusions 22 on the outer circumferential surface of the supporter 21—, and if one unit body 20 is stacked and coupled with another unit body 20, the plural vortex-generating protrusions 22 of the stacked supporters 21 may intermittently form a plurality of helical (or screw-shaped) paths S1, S2, S3, . . . , Sn along the outer circumferential surface of the microbubble generating device 1b. Furthermore, the plural first inner vortex-generating protrusions 22a of the stacked inner supporters 21a may also intermittently form a plurality of helical (or screw-shaped) paths along the outer circumferential surfaces of the plural inner supporters 21a provided inside the microbubble generating device 1b.

Additionally, the number of the first inner vortex-generating protrusions 22a provided on the outer circumferential surface of the inner supporter 21a and the number of the vortex-generating protrusions 12 provided on the outer circumferential surface of the supporter 11 may be identical, but are not limited thereto and may differ. Furthermore, the protrusion direction of the first inner vortex-generating protrusions 22a on the outer circumferential surface of the inner supporter 21a and the protrusion direction of the vortex-generating protrusions 12 on the outer circumferential surface of the supporter 11 may also be identical, but are not limited thereto and may differ.

The present invention is not particularly limited in this regard, but according to a particular embodiment, the number of the first inner vortex-generating protrusions 22a on the outer circumferential surface of the inner supporter 21a and the number of the vortex-generating protrusions 12 on the outer circumferential surface of the supporter 11 may each be eight and thus identical, as shown in FIG. 8 and the like. However, the protrusion directions of the first inner vortex-generating protrusions 22a on the outer circumferential surface of the inner supporter 21a and the vortex-generating protrusions 12 on the outer circumferential surface of the supporter 11 may differ regardless of each other.

Therefore, according to an embodiment of the present invention, the fluid flowing in the fluid flow direction may collide under a predetermined pressure not only with the vortex-generating protrusions 22 of the microbubble generating device 1b but also with the first inner vortex-generating protrusions 22a. As a result, bubbles contained in the fluid may be broken into smaller bubbles on both the inner and outer sides of the microbubble generating device 1b, and repeated splitting of the bubbles may generate a large quantity of microbubbles.

As described above, the inner supporter 21a may be ring-shaped (or hollow cylindrical), and one side, specifically the front or rear, of the inner supporter 21a may include a plurality of inner coupling grooves 23a spaced apart at a predetermined interval along its edge. Correspondingly, the other side, specifically the rear or front, of the inner supporter 21a may include a plurality of inner coupling protrusions 24a spaced apart at a predetermined interval along its edge.

Accordingly, when the coupling grooves 13 provided on one supporter 11 and the coupling protrusions 14 provided on another supporter 11 to correspond thereto are fitted and coupled with each other, inner coupling grooves 23a provided on one inner supporter 21a and inner coupling protrusions 24a provided on another inner supporter 21a to correspond thereto may also be fitted and coupled together.

Here, although the present invention is not particularly limited, the coupling grooves 13 and the inner coupling grooves 23a may be arranged radially in parallel with respect to the central axis, and the coupling protrusions 14 and the inner coupling protrusions 24a may also be arranged radially in parallel with respect to the central axis. However, the present invention is not limited thereto.

Meanwhile, an inner module according to an embodiment of the present invention may further include, in addition to the inner supporter 21a and the plural first inner vortex-generating protrusions 22a provided on its outer circumferential surface, a plurality of second inner vortex-generating protrusions 22b provided on its inner circumferential surface.

In other words, the second inner vortex-generating protrusions 22b may be radially protruded from the outer circumferential surface of a central axis 21b.

The plural second inner vortex-generating protrusions 22b, which are provided on either the inner circumferential surface of the inner supporter 21a or the outer circumferential surface of the central axis 21b, are not particularly limited in shape, and similarly to the vortex-generating protrusions 12 or the first inner vortex-generating protrusions 22a, may have a cross-sectional shape of a parallelogram with its top side or bottom side facing the fluid flow direction as shown in FIG. 11(a) or a cross-sectional shape of a rhombus with one of its vertices facing the fluid flow direction as shown in FIG. 11(b), so that bubbles contained in the fluid may be broken into smaller bubbles when colliding with the fluid flowing in the fluid flow direction.

In addition, although the number of the second inner vortex-generating protrusions 22b protruding from the outer circumferential surface of the central axis 21b is not particularly limited in the present invention, it may be six, according to a particular embodiment.

When the plural second inner vortex-generating protrusions 22b are provided on the outer circumferential surface of the central axis 21b, concave central coupling grooves 24b may be formed on the “front” or “rear” side of the central axis 21b, and correspondingly, central coupling protrusions 23b may be formed to protrude on the rear or front side of the central axis 21b.

Accordingly, when one coupling groove 13 provided on the supporter 11 is fitted and coupled with another coupling protrusion 14 provided on the supporter 11, one central coupling groove 24b provided on the central axes 21b may simultaneously be fitted and coupled with another central coupling protrusion 23b provided on the central axis 21b. That is, the central coupling protrusions 23b and the central coupling grooves 24b may be formed at corresponding positions on the central axis 21b so as to be engageable with each other.

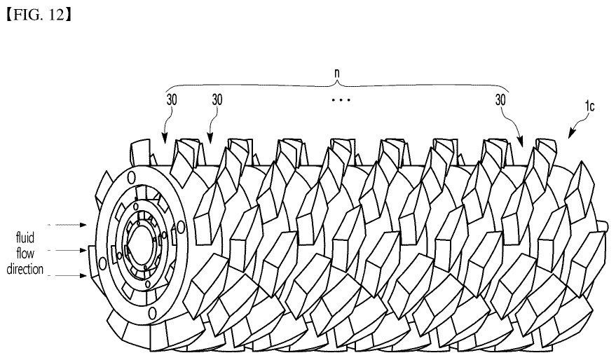

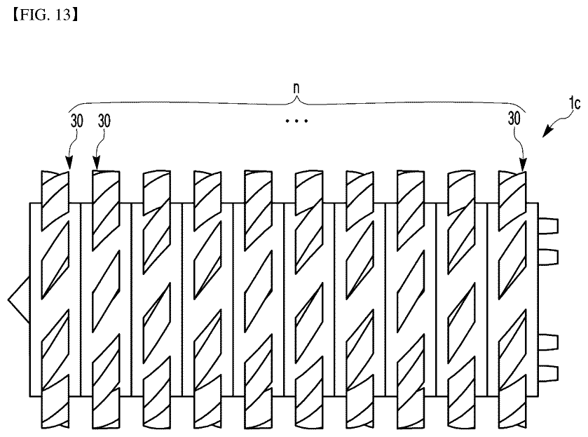

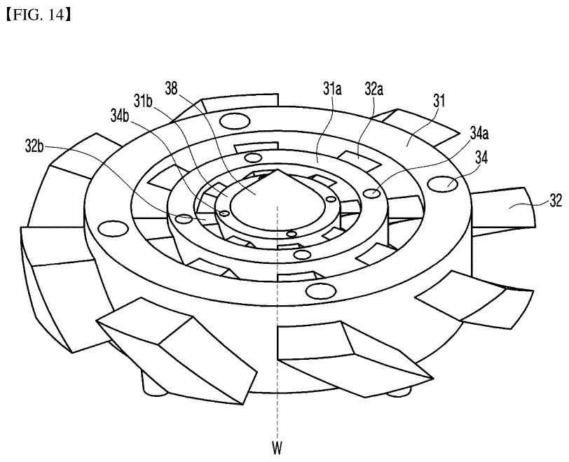

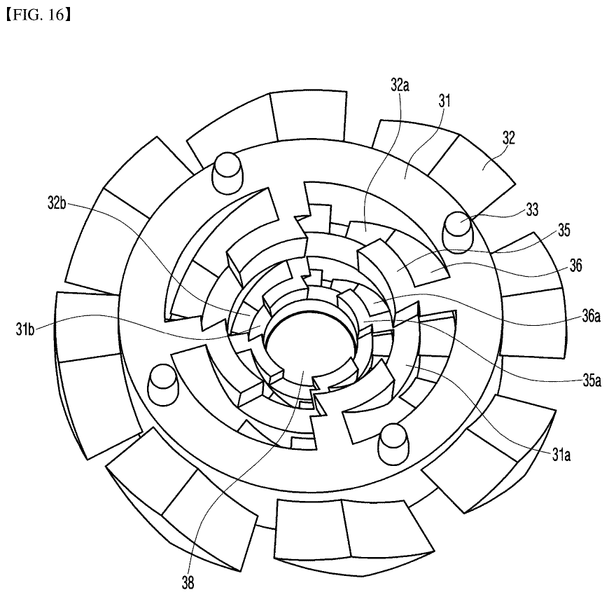

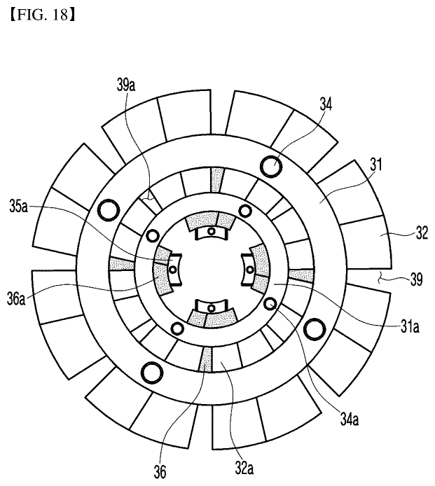

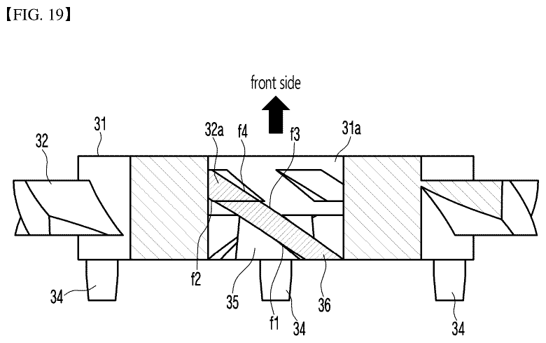

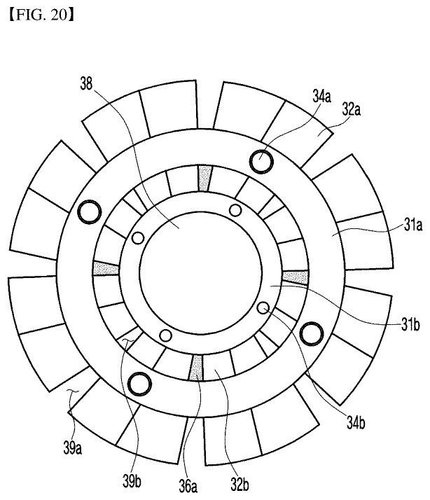

According to another embodiment of the present invention, FIGS. 12 and 13 illustrate an overall view in which a plurality of unit bodies having an inner module that is coupled with another unit body are stacked. FIGS. 14 to 17 respectively illustrate the overall view, front, rear, and exploded perspective view of the unit bodies in FIG. 12. FIGS. 18 and 19 respectively illustrate a view where the innermost unit body is omitted from the unit body of FIG. 12 and a certain longitudinal cross-sectional view. FIG. 20 illustrates a view where the outermost unit body is omitted from the unit body of FIG. 12.

As shown in FIGS. 12 to 20, the inner module of each unit body 30 according to an embodiment of the present invention may be another unit body 31a to 34a or 31b to 34b having a different outer diameter of the supporter 31. That is, the inner module of the unit body 30 having a plurality of vortex-generating protrusions 32 on its outer circumferential surface may include one or more additional unit bodies 31a to 34a or 31b to 34b repeatedly arranged.

That is, on the inner circumferential surface of one of the unit bodies 30, another unit body 31a to 34a or 31b to 34b having a supporter 31a of relatively smaller outer diameter may be provided repeatedly one or more times. Preferably, the another unit body 31a to 34a or 31b to 34b may be configured to be detachably attached.

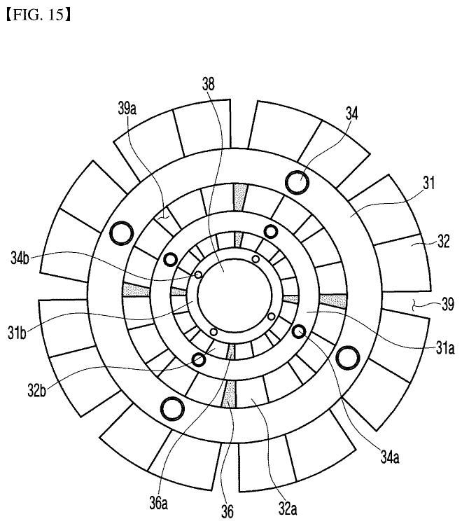

For example, FIG. 18 illustrates a configuration in which another unit body 31a to 34a is coupled to the inside of the outermost unit body 30. FIG. 20 illustrates a configuration in which another unit body 31a to 34a is coupled to the outside of the innermost unit body 31b to 34b. FIG. 15 illustrates a configuration in which three unit bodies 30, 31a to 34a and 31b to 34b having different diameters are coupled to the inner and outer sides.

Accordingly, by repeatedly coupling another unit body 31a to 34a or 31b to 34b to the inner and/or outer side of one unit body 30, the diameter of the microbubble generating device 1c structure may be easily extended in a radial direction, and by repeatedly stacking and coupling one unit body 30, 31a to 34a, or 31b to 34b in the front and/or rear direction, the length of the microbubble generating device 1c structure may be easily extended in a longitudinal direction.

When another unit body 31a to 34a or 31b to 34b is provided on the inner circumferential surface of the ring-shaped supporter 31 having a plurality of vortex-generating protrusions 32 on its outer circumferential surface, each of the unit bodies 31a to 34a or 31b to 34b may have vortex-generating protrusions 32, 32a, or 32b with the same or different shape which are repeatedly arranged in the inward and/or outward direction.

As illustrated in the drawings, a plurality of vortex-generating protrusions 32 provided on the outer circumferential surface of the supporter 31 may have a parallelogram-shaped cross-section, and the vortex-generating protrusions 32a of another unit body 31a to 34a provided on the inner circumferential surface of the supporter 31 may also have a parallelogram-shaped cross-section. Furthermore, the vortex-generating protrusions 32b of another unit body 31b to 34b, provided as an inner module of another unit body 31a to 34a, may also have a parallelogram-shaped cross-section, but the present invention is not particularly limited thereto.

Here, a direction w in which the vortex-generating protrusions 32 of a supporter 31 are extended radially outward from the center, and a direction w in which the vortex-generating protrusions 32a of another unit body 31a to 34a, provided on the inner circumferential surface of the supporter 31, are also extended radially outward from the center, may coincide with each other, but the present invention is not particularly limited thereto.

Accordingly, microbubbles may be generated from fluid that collides with the vortex-generating protrusions 32 of the unit body 31 provided at the outermost position with respect to the center, and microbubbles may also be generated from fluid that collides with the vortex-generating protrusions 32b of the unit bodies 31b to 34b provided at the innermost position. In addition, by generating microbubbles from fluid that collides with the vortex-generating protrusions 32a of the unit bodies 31a to 34a provided between the innermost and outermost positions, a large amount of microbubbles may be produced.

In addition, when the plural unit bodies 30, 31a to 34a, and 31b to 34b are repeatedly coupled in a radial direction, the inner modules of the innermost unit bodies 31b to 34b may have a conical shape with a predetermined height protruding to face the fluid flow direction, so that microbubbles may be generated and, at the same time, the resistance to the flowing fluid may be reduced, but the present invention is not particularly limited.

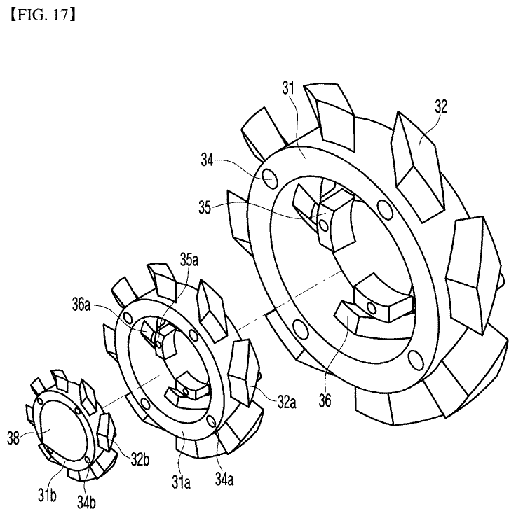

Meanwhile, as shown in FIG. 17 and the like, the inner side of the supporter 31 of any one of the unit bodies 30 according to an embodiment of the present invention may include at least one seating part 35 so that another unit body 31a to 34a may be seated therein.

In this case, the supporter 31a of any one of the unit bodies 31a to 34a may be seated in the seating part 35 of another unit body 30, and the seating part 35 and a seated part, i.e., the supporter 31a, may be provided with pairs of coupling grooves and coupling protrusions or with pairs of coupling protrusions and coupling grooves to be mutually coupled, but the present invention is not particularly limited thereto.

The seating part 35 of any one of the unit bodies 30 may be formed to extend inward by a predetermined distance from the inner circumferential surface of the supporter 31 so as to allow the supporter 31a of another unit body 31a to 34a to be coupled thereto. However, according to a preferred embodiment of the present invention, a wing part 36 may be interposed between the seating part 35 and the inner circumferential surface of the supporter 31.

More preferably, the wing part 36 may include wing-extension surfaces f1 and f3 that are configured to engage with the vortex-generating protrusions 32a protruding from the outer circumferential surface of the supporter 31a when the supporter 31a of another unit body 31a to 34a is seated as a seated part on the seating part 35 and that are formed to extend continuously from wing surfaces f2 and f4 formed in a circumferential direction of the vortex-generating protrusions 32a (see FIG. 19).

The number of the wing parts 36 (or the seating parts 35) of any one of the unit bodies 30 may be less than the number of the vortex-generating protrusions 32a of another unit body 31a to 34a seated in the seating part 35, and the resistance to the fluid flowing in the fluid flow direction may be reduced by making at least some of the wing surfaces f2 and f4 of the vortex-generating protrusions 32a of the seated another unit body 31a to 34a longer along the fluid flow direction.

Here, the supporter 31a of another unit body 31a to 34a may also include at least one seating part 35a on its inner side to allow another unit body 31b to 34b to be seated, and a wing part 36a may be interposed between the seating part 35a and the inner circumferential surface of the supporter 31a. The wing part 36a may also include wing-extension surfaces that engage with the vortex-generating protrusions 32b protruding from the outer circumferential surface of the supporter 31b when the supporter 31b of another unit body 31b to 34b is seated as a seated part in the seating part 35a, and extend continuously from the wing surfaces formed in a circumferential direction of the vortex-generating protrusions 32b.

An unreferenced reference numeral 39 in FIG. 18 may indicate a space through which fluid may flow between the vortex-generating protrusions 32 provided on the outermost unit body 30, an unreferenced reference numeral 39b in FIG. 20 may indicate a space through which fluid may flow between the vortex-generating protrusions 32b of the innermost unit body 31b to 34b, and an unreferenced reference numeral 39a in FIG. 20 may indicate a space through which fluid may flow between the vortex-generating protrusions 32a disposed between the outermost and the innermost unit bodies 31a to 34a.

The preferred embodiments of the present invention have been described in detail above with reference to the accompanying drawings. However, this description is provided by way of example only. Those skilled in the art to which the present invention pertains will appreciate that various modifications and other specific forms can be made without departing from the technical spirit or essential features of the invention.

Therefore, the scope of the present invention should be defined not by the foregoing detailed description, but by the accompanying claims. It is to be understood that all modifications or variations derived from the meaning, scope, and equivalents of the claims are included within the scope of the present invention.

1. A microbubble generating device, comprising:
at least one unit body, the unit body comprising:
at least one ring-shaped supporter;
a plurality of vortex-generating protrusions spaced apart at a predetermined interval along an outer circumferential surface of the supporter;
an inner module provided inside the supporter;
a plurality of coupling grooves spaced apart at a predetermined interval along an edge of one side of the supporter; and
a plurality of coupling protrusions formed to protrude at positions corresponding to the coupling grooves and spaced apart at a predetermined interval along an edge of another side of the supporter such that the coupling protrusions can be fitted and coupled to the coupling grooves when the plural supporters are stacked,
wherein, when the plural unit bodies are stacked, the vortex-generating protrusions are formed as a plurality of intermittent helical projections spaced apart at a predetermined interval along an outer circumferential surfaces of the plural supporters.

2. The microbubble generating device according to claim 1, wherein the inner module has a conical shape with a predetermined height.

3. The microbubble generating device according to claim 2, wherein when the plural unit bodies are stacked, the inner module, which has the conical shape, is fitted and coupled to a supporter of another one of the stacked unit bodies.

4. The microbubble generating device according to claim 1, wherein an angle formed between one of the coupling grooves and a coupling groove adjacent thereto is 90 degrees based on a central axis of the supporter.

5. The microbubble generating device according to claim 1, wherein the inner module comprises:
an inner supporter; and
a plurality of first inner vortex-generating protrusions spaced apart at a predetermined interval along an outer circumferential surface of the inner supporter.

6. The microbubble generating device according to claim 5, wherein the first inner vortex-generating protrusions have a rhombus-shaped cross-section with a predetermined height and thickness.

7. The microbubble generating device according to claim 5, wherein the inner module comprises:
a plurality of inner coupling grooves spaced apart at a predetermined interval along an edge of one side of the inner supporter; and
a plurality of inner coupling protrusions spaced apart from each other at a predetermined interval to protrude at corresponding positions along an edge of another side of the inner supporter, so as to be coupled to another one of the inner coupling grooves when the plural unit bodies are stacked.

8. The microbubble generating device according to claim 5, wherein the inner module comprises:
a central coupling protrusion protruding from a central axis; and
a central coupling groove formed at a position corresponding to the central coupling protrusion so as to be engageable when the plural unit bodies are stacked.

9. The microbubble generating device according to claim 8, wherein the inner module comprises a plurality of second inner vortex-generating protrusions spaced apart at a predetermined interval along an outer circumferential surface of the central axis.

10. The microbubble generating device according to claim 1, wherein the inner module is another unit body having an outer diameter smaller than that of the supporter, and is attachable to and detachable from the supporter.

11. The microbubble generating device according to claim 10, wherein the inner module further comprises:
a seating part provided on an inner side of the supporter so that another unit body is seated in the seating part; and
a wing part configured to extend wing surfaces by engaging with vortex-generating protrusions of the another unit body when the another unit body is seated in the seating part.

12. The microbubble generating device according to claim 11, wherein the supporter of the another unit body is seated in the seating part.

13. The microbubble generating device according to claim 10, wherein a direction in which the vortex-generating protrusions of the supporter extend outward from a center, and a direction in which the vortex-generating protrusions of the another unit body extend outward from a center, coincide with each other.

14. The microbubble generating device according to claim 11, wherein the inner module of the another unit body has a conical shape with a predetermined height.
